(19) United States
(12) Patent Application Publication
(10) Pub. No.: US 2016/0078495 A1
(43) Pub. Date: Mar. 17, 2016

(54) Determining Compensation to an Online System from an Entity for Presenting Third Party Content in Content Associated with Another Online System User

(71) Applicant: Facebook, Inc., Menlo Park, CA (US)

(72) Inventors: Asad K. Awan, San Francisco, CA (US); Maria Angelidou, Menlo Park, CA (US); David Tin Ho Shih, San Francisco, CA (US)

(21) Appl. No.: 14/485,543

(22) Filed: Sep. 12, 2014

(51) Int. Cl. G06Q 30/02

(52) U.S. Cl. CPC G06Q 30/0273; G06Q 30/0277; G06Q 50/01

(57) ABSTRACT

An online system may prevent a content associated with a user from including content that is sponsored by a third party, other than the user, for presentation on by the online system unless the user provides an amount of compensation to the online system. To determine an amount of compensation, the online system determines an amount of reach of the content sponsored by the third party based on characteristics of the content associated with the user. For example, a number of users viewing the content associated with the user is used to determine the amount of reach of the content if it is presented by via the content associated with the user. Based on the amount of reach, the online system determines an amount of compensation to be received from the user to present the content sponsored by the third party via the content associated with the user.

### BACKGROUND

This disclosure relates generally to online systems, and more specifically to presentation of content on a page maintained by an online system for an entity.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for entities, such as retailers or service providers, to increase awareness about products or services by presenting content to online system users.

Presenting content items to online system users allows an entity (e.g., a retailer, a service provider, a restaurant) to gain public attention for products or services or to persuade online users to take an action regarding the entity's products or services. Additionally, many online systems generate revenue by receiving compensation from entities for presenting certain content items to their users. Frequently, online systems charge an entity for each presentation of certain types of content items to an online system user (e.g., each “impression” of the content item) or for each interaction with certain types of content items by an online system user.

Additionally, an entity may maintain a page or other content on an online system to which the entity posts content. Users of the online system access the page or other content to receive information from the entity, allowing the entity to easily provide information to online system users. However, many conventional online systems have one or more policies limiting types of content items an entity may post to its corresponding page on the online system. For example, many conventional online systems prevent an entity from posting content items on its associated page that are sponsored by a third party. This prevents the third party from sponsoring content presented via the entity's page on the online system, but also prevents the entity from receiving compensation from the third party in exchange for presenting content items via the entity's page on the online system.

### SUMMARY

An online system maintains a set of content items associated with an entity and presents content posted to a content item in the set of content items by the entity to other users of the online system. For example, the online system maintains a page associated with the entity and presents content to other users having a connection to the page. The entity may be any user of the online system, such as an individual user, a company, or a charity. In various embodiments, the online system may enforce one or more policies regulating or limiting the types of content capable of being presented in a content item provided to the online system by the entity. For example, the online system may restrict presentation of content sponsored by a third party other than the entity on a page or in a content item associated with another online system users (e.g., in a content item associated with a user other than the entity and presented to other online system users in a feed) associated with the entity or may prevent presentation of certain types of content (e.g., content determined to be vulgar) via a page or feed associated with an entity.

However, the online system may allow an entity to disseminate content sponsored by a third party through content items associated with the entity if certain conditions are satisfied. In various embodiments, the online system may allow presentation of content sponsored by a third party in one or more content items associated with an entity if the entity provides a threshold amount of compensation to the online system. When the online system receives a request from the entity to present content associated with a third party other than the entity in a content item associated with the entity, the online system determines an amount of compensation to be provided by the entity to the online system to present the content associated with the third party via the content item associated with the entity. For example, the entity requests to present content associated with a third party other than the entity via a page maintained by the online system and associated with the entity. One or more characteristics of the content items associated with the entity may be used by the online system to determine the amount of compensation. For example, the online system determines an amount of reach of the content associated with the third party if presented via content associated with the entity based on prior interactions with content items associated with the user. As an example, if the content is associated with the third party and is requested to be presented on a page associated with the entity, prior interactions with the page associated with the entity are used to determine the amount of reach of the page. The amount of reach provides a measure of a number of users of the online system potentially viewing the content if presented via content, or a content item, associated with the entity. In some embodiments, the amount of reach is determined at least in part on a number of online system users that previously interacted with the one or more types of content associated with the entity (e.g., previously interacted with a page associated with the entity) or that previously performed a specific type of interaction with content associated with the entity (e.g., with a page associated with the entity). Additional characteristics associated with the content associated with the entity may be used to determine the amount of reach for the content. Examples of additional characteristics include: a frequency with which interactions with the set of content items are received by the online system, attributes of users that interacted with the set of content items, attributes of the content, and a change in interaction with the content associated with the entity by online system users over a specified time interval. In some embodiments, the measure of reach may be based on a number of discrete users that interacted with the content associated with the entity. The amount of compensation may be proportional to the measure of reach.

The third party may specify an amount of compensation to the entity for presenting the content via content associated with the entity (e.g., a page), so the online system may request information from the entity describing the amount received by the entity if the content is presented via the entity's content. Based on the amount received by the entity, the online system determines an amount of compensation to receive from the entity to present the content using the entity's content. For example, the determined amount of compensation is a percentage of the amount received by the entity or is a percentage or multiple of a budget allocated for the content by the third party.

The online system presents a notification to the entity identifying the determined amount of compensation. A prompt requesting the entity to agree to pay the determined amount of compensation to the online system is included in the notification. If the user communicates a response to the notification agreeing to provide the determined amount of compensation to the online system if the content sponsored by the third party is presented via the entity's content maintained by the online system, the content sponsored by the third party system associated with the entity's content for presentation and the online system charges the entity the determined amount. In one embodiment, the entity provides the determined amount of compensation to the online system before the content is presented via the entity's content item. Alternatively, the response to the notification includes an agreement by the entity to provide the online system with the determined amount of compensation, and the content sponsored by the third party is presented via the entity's content and the entity is subsequently charged the determined amount of compensation by the online system.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of a method for determining an amount of compensation to an online system for presenting content associated with a third party on a page associated with a user and maintained by the online system, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

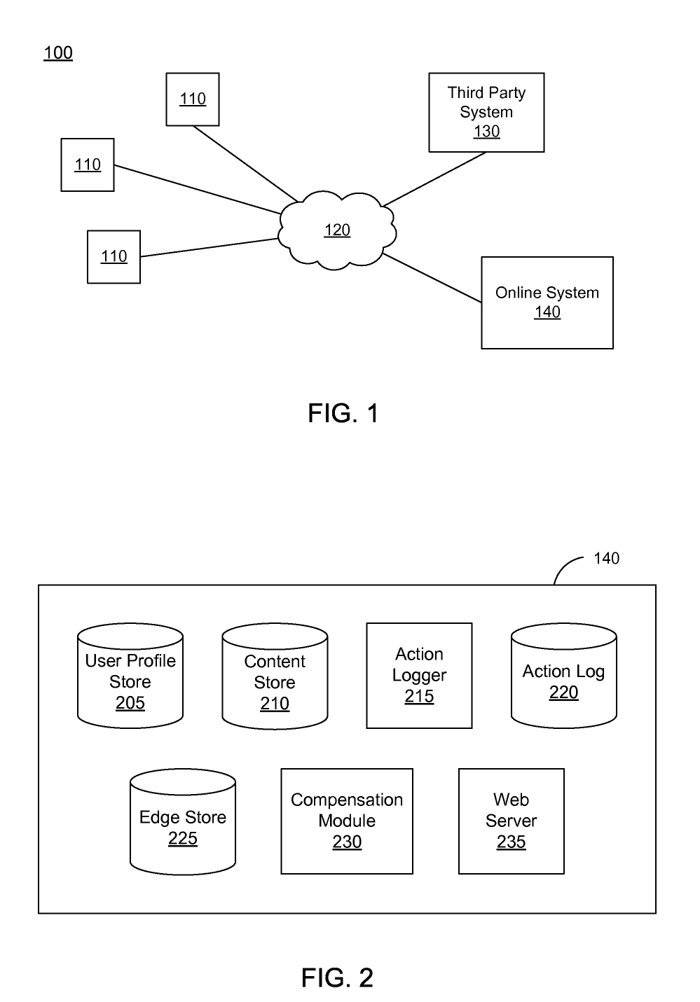

FIG. 1 is a block diagram of a system environment 100 for an online system 140, such as a social networking system. The system environment 100 shown by FIG. 1 comprises one or more client devices 110, a network 120, one or more third-party systems 130, and the online system 140. In alternative configurations, different and/or additional components may be included in the system environment 100.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, a compensation module 230, and a web server 235. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a page (e.g., brand page), or any other type of content. Online system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate a user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

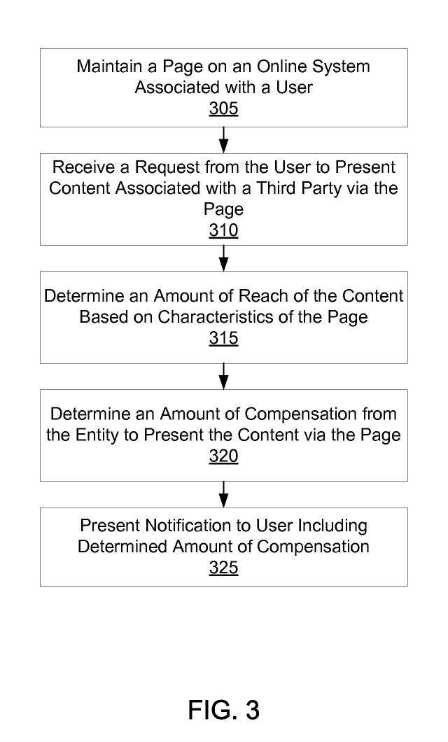

The compensation module 230 receives a request from a user of the online system 140, such as an entity, associated with one or more content items maintained by the online system 140 to present content associated with a third party, such as content sponsored by the third party, on the page maintained by the online system 140 and associated with the entity. Based on characteristics of the user's one or more content items, the compensation module 230 determines an amount of compensation to request from the user to present the content associated with the third party via the user's content maintained by the online system 140. For example, the compensation module 230 determines an amount of reach for the content if it is presented via a page associated with the user and including content items associated with the user based on prior interactions with the user's page by online system users. The amount of reach provides a measure of exposure of the content associated with the third party if it is presented to online system users via the user's content. For example, the amount of reach is based on a number of distinct online system users that interacted with the user's one or more content items (e.g., a page associated with the user) within a specified time interval, a number of online system users that interacted with the user's one or more content items (e.g., a page associated with the user) within the specified time interval, a number of distinct online system users performing a specific type of interaction with the user's one or more content items (e.g., expressing a preference for one or more of the user's content items, commenting on one or more of the user's content items, sharing one or more of the user's content items with other users) within the specified time interval, or based on any other suitable characteristic of the one or more content items associated with the user. Other information may be used to determine the amount of reach of the content associated with the third party, as further described below in conjunction with FIG. 3. Based at least in part on the amount of reach, the compensation module 230 determines the amount of compensation, as further described below in conjunction with FIG. 3. The determined amount of compensation is presented to the user, and if the user agrees to provide the online system 140 with the determined amount of compensation or provides the online system 140 with the determined amount of compensation, the content associated with the third party is included on the user's one or more content items, which is presented to additional users of the online system 140.

The web server 235 links the online system 140 via the network 120 to the one or more client devices 110, as well as to the one or more third party systems 130. The web server 235 serves web pages, as well as other content, such as JAVA®, FLASH®, XML and so forth. The web server 235 may receive and route messages between the online system 140 and the client device 110, for example, instant messages, queued messages (e.g., email), text messages, short message service (SMS) messages, or messages sent using any other suitable messaging technique. A user may send a request to the web server 235 to upload information (e.g., images or videos) that are stored in the content store 210. Additionally, the web server 235 may provide application programming interface (API) functionality to send data directly to native client device operating systems, such as IOS®, ANDROID™, WEBOS® or BlackberryOS.

### Determining Compensation for Presenting Third Party Content on an Online System User's Page

FIG. 3 is a flowchart of one embodiment of a method for determining an amount of compensation for presenting content associated with a third party on a page maintained by the online system 140 and associated with a user. For purposes of illustration, FIG. 3 describes an example where content associated with a third party is presented on a page associated with a user. However, in other embodiments, the content associated with a third party may be presented via an individual content item associated with the user. For example, content associated with the third party is included in a content item associated with a user and presented in a newsfeed to another user connected to the user, presented as a content item included in a timeline associated with the user, or a content item associated with the user and presented to one or more other online system users. In other embodiments, the method may include different and/or additional steps than those shown in FIG. 3. Additionally, steps of the method may be performed in different orders than the order described in conjunction with FIG. 3.

An online system 140 maintains 305 a page associated with a user; in other embodiments, any suitable content may be maintained 305 by the online system 140 and associated with the user. The user may be an entity, such as business, organization, charity, or group, or may be an individual user of the online system 140. The embodiment described in conjunction with FIG. 3 describes a page associated with the user and including content items provided to the online system 140 by the user as well as other information provided to the online system 140 by the user. However, in other embodiments, information describing any content item or set of content items associated with the user may be maintained 305, such as content items included in a feed of content items presented to other online system users. Additional users of the online system 140 may perform different types of interactions with the page, or with other content associated with the user. For example, an additional user indicates a preference for the page (“likes” the page), shares the page with another user, provides a comment to the page, etc. Similar interactions may be performed with other content associated with the user and maintained 305 by the online system 140. Examples of content maintained 305 by the online system include a page associated with a business, a page associated with a company, a page associated with a public figure (e.g., an actor, a celebrity, a musician), a timeline, or a news ticker. The online system 140 may store and maintain 305 the page or other content in the content store 210.

The online system 140 receives 310 a request from the user to present content associated with a third party via the page. In other embodiments, the online system 140 receives 310 a request from the user to present content associated with a third party via other content associated with the user (e.g., content items included in a timeline associated with the user, a content item the user posts to a timeline of another user). The third party is different from the user associated with the page. For example, if the page is associated with a company, the third party is another company. In another example, the page or other content is associated with any suitable user of the online system 140. While the third party may be another user of the online system 140, the third party may not be a user of the online system 140. In one embodiment, the third party provides compensation to the user associated with the page in exchange for presentation of the content associated with the third party via the page associated with the user. The content may be associated with an amount provided to the user by the third party if the content is presented via the user's page. For example, the content includes advertisement content associated with a bid amount specifying an amount the third party provides the user for each user of the online system 140 presented with the content via the user's page or an amount the third party provides the user for each user of the online system 140 performing an interaction with the content presented by the user's page. The third party may also identify a budget to the user specifying a total amount of compensation the third party will provide the user for presenting the content via the user's page. Examples of content associated with the third party for presentation via the user's page include content promoting a product or service of the third party, content promoting an attribute of the third party (e.g., a brand name, a logo, a motto, an image, etc.), or content promoting an event associated with the third party. The content associated with the third party may be a post, a link, an article, a video, or any other suitable content item as described in conjunction with FIG. 2.

In some embodiments, rather than receiving 310 a request from the user, the online system 140 analyzes content received from the user to determine if the content is associated with a third party other than the user. For example, the online system 140 receives content from the entity and analyzes attributes of the content to determine whether the content is associated with a third party other than the user. Example attributes of the content include: a network address associated with the content, one or more images included in the content, text included in the content, frames in a video associated with the content, or metadata associated with the content. The online system 140 may compare attributes of the content to data associated with users, such as entities, maintained by the online system 140 and if at least a threshold number of attributes of the content match data other than data associated with the user, the online system 140 presents a notification to the user that the content is associated with another user and requests additional information about the content from the user.

Based on one or more characteristics of the user's page, the online system 140 determines 315 an amount of reach of the content if it is presented by the user's page. The amount of reach provides a measure of a number of online system users exposed to the content via the user's page. In various embodiments, the measure of reach identifies a number of distinct online system users capable of accessing the content via the user's page. The amount of reach is determined 315 at least in part from prior interactions with the user's page by online system users. For example, a number of distinct users having established a connection with the user's page is used to determine 315 the amount of reach. As another example, a number of distinct users having performed a specific type of interaction with the user's page is used to determine 315 the amount of reach of the content. Other examples of characteristics for determining 315 the amount of reach include: a number of users performing a type of interaction with the user's page within a specified time interval, an average frequency with which users interact with the user's page, a change in an amount of user interaction with the page over a specified time interval, a number of times the page is viewed or accessed during a specified time interval, a number of users connected to the page via the online system 140, a number of times the page has been accessed by online system users, or a number of discrete online system users performing one or more types of interactions with the page during a specified time interval. If the content associated with the third party is to be presented via content associated with the user other than a page, similar information may be used to determine 315 the amount of reach for the content associated with the third party. Example information for determining the amount of reach of the content associated with the third party include: a number of users performing a type of interaction with content associated with the user and having one or more attributes matching or similar to attributes of the content associated with the user with which the content associated with the third party is to be presented, a number of users performing a type of interaction with content associated with the user and having one or more attributes matching or similar to attributes of the content associated with the user with which the content associated with the third party is to be presented in a threshold time interval, a number of discrete users performing a type of interaction with content associated with the user and having one or more attributes matching or similar to attributes of the content associated with the user with which the content associated with the third party is to be presented, or a frequency with which users perform a type of interaction with content associated with the user and having one or more attributes matching or similar to attributes of the content associated with the user with which the content associated with the third party is to be presented.

Information associated with the content as well as with users that interacted with the page or with other content associated with the user may also be used when determining 315 the amount of reach of the content. For example, metadata associated with the content may identify one or more attributes of users that the third party desires to view the content, so the amount of reach of the content is determined 315 based on interactions by users having at least a threshold number of the identified attributes that previously interacted with the page or that previously interacted with other content associated with the user. As an example, the amount of reach is determined 315 as a number of discrete users of the online system 140 that indicated a preference for the page within a specified time interval and have at least a threshold number of attributes maintained by the online system 140 matching attributes associated with the content. In another example, the amount of reach is determined 315 as a number of users of the online system 140 having a connection to the page and having at least a threshold number of attributes maintained by the online system 140 matching attributes associated with the content. Characteristics of the page (e.g., a topic associated with the page, one or more users associated with the page) may also be used when determining 315 the amount of reach of the content. Similarly, if the content associated with the third party is requested to be presented with another type of content associated with the user, information similar to that descried above associated with the other type of content may be used to determine 315 the amount of reach of the content associated with the third party.

Based on the determined reach of the content, the online system 140 determines 320 an amount of compensation for the online system 140 to receive from the user in exchange for the user presenting the content associated with the third party via the user's page. For example, the amount of compensation is determined 320 based on a monetary value associated with users accessing the page and the amount of reach. As an example, the amount of compensation is a product of a monetary amount per user and a number of discrete users performing an interaction with the page within a specified time interval. Alternatively, different amounts of compensation are associated with different ranges of amounts of reach and the amount of compensation is determined as an amount of compensation associated with a range of amounts of reach including the determined amount of reach. If the content is associated with an amount provided to the user by the third party if the content is presented via the user's page, the determined 320 amount of compensation may be a percentage of the amount provided to the user by the third party that is based on the determined amount of reach (e.g., a percentage of an amount the user receives from the third party for each presentation of the content or interaction with the content or a percentage of a budget for presentation of the content specified by the third party). An amount of compensation for presenting the content associated with the third party via other types of content associated with the user (e.g., a specific content item, a timeline associated with the user, a content item the user communicates to another user) may be similarly determined 320.

The online system 140 presents 325 a notification including the determined amount of compensation to the user through any suitable channel (e.g., text message, e-mail, push notification, etc.). In addition to the determined amount of compensation, the notification includes a mechanism for the user to provide the determined amount of compensation to the online system 140 or to agree to provide the determined amount of compensation to the online system 140. If the online system 140 receives an agreement from the user to provide the determined amount of compensation or receives the determined amount of compensation from the user, the online system 140 presents the content associated with the third party via the page associated with the user. Hence, the content associated with the third party is accessible to other online system users (“viewing users”) capable of accessing the page. Similarly, in other embodiments, the online system 140 presents the content associated with the third party via another type of content associated with the user, such as a content item the user communicates to a viewing user, a content item the user posts to a page associated with a viewing user, or a content item associated with the user and included in a feed of content items presented to a viewing user. However, if the online system 140 receives an indication from the user that the user does not agree to provide the online system 140 with the determined amount of compensation, the content associated with the third party is not presented by the online system 140 via the page associated with the user.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
maintaining content on an online system associated with a user;
receiving a request from the user to present content associated with a third party other than the user via content associated with the user;
determining an amount of reach of the content associated with the third party to users of the online system based on one or more characteristics of the content associated with the user;
determining an amount of compensation to receive from the user for presenting the content associated with the third party to users of the online system via the content associated with the user based at least in part on the determined amount of reach of the content associated with the third party; and
presenting a notification to the user of the determined amount of compensation.

2. The method of claim 1, wherein the content associated with the user comprises a page associated with the user and the amount of reach of the content associated with the third party is based at least in part on a number of discrete users of the online system performing a type of interaction with the page within a specified time interval.

3. The method of claim 2, wherein the type of interaction is selected from a group consisting of: establishing a connection to the page, indicating a preference for the page, sharing the page with another user of the online system, providing a comment for presentation via the page, and any combination thereof.

4. The method of claim 1, wherein the content associated with the user is a page associated with the user and a characteristic of the content associated with the user is selected from a group consisting of: an average frequency with which users of the online system interact with the page within a specified time interval, a change in an amount of user interaction with the page over the specified time interval, a number of times the page is accessed during the specified time interval, and any combination thereof.

5. The method of claim 1, wherein the amount of reach of the content associated with the third party is based at least in part on a number of discrete users of the online system accessing the content associated with the user via the online system.

6. The method of claim 1, wherein the amount of reach of the content associated with the third party is based at least in part on a number of times the content associated with the user has been accessed by users of the online system.

7. The method of claim 1, wherein the amount of reach of the content associated with the third party is based at least in part on a number of users of the online system accessing the content associated with the third party and having at least a threshold number of attributes matching attributes associated with the content associated with the third party.

8. The method of claim 1, wherein the content associated with the third party is associated with an amount provided to the user by the third party and the amount of compensation to receive from the user is a portion of the amount provided to the user, the portion determined at least in part by the determined amount of reach.

9. The method of claim 1, wherein determining the amount of compensation to receive from the user for presenting the content associated with the third party from the user to present the content to users of the online system via the content associated with the user comprises:
associating amounts of compensation with different ranges of amounts of reach of the content associated with the third party; and
selecting an amount of compensation associated with a range of amounts of reach including the determined amount of reach associated with the third party.

10. The method of claim 1, wherein the amount of compensation is proportional to the determined amount of reach of the content associated with the third party.

11. The method of claim 1, further comprising:
receiving an agreement from the user to provide the online system with the determined amount of compensation; and
responsive to receiving the agreement, presenting the content associated with the third party to the users of the online system via the content associated with the user.

12. The method of claim 1, wherein the user is an entity.

13. A computer program product comprising a computer-readable storage medium having instructions encoded thereon that, when executed by a processor, cause the processor to:
maintain content on an online system associated with a user;
receive a request from the user to present content associated with a third party other than the user via content associated with the user;
determine an amount of reach of the content associated with the third party to users of the online system based on one or more characteristics of the content associated with the user;
determine an amount of compensation to receive from the user for presenting the content associated with the third party to users of the online system via the content associated with the user based at least in part on the determined amount of reach of the content associated with the third party; and
present a notification to the user of the determined amount of compensation.

14. The computer program product of claim 13, wherein the content associated with the user comprises a page associated with the user and the amount of reach of the content associated with the third party is based at least in part on a number of discrete users of the online system performing a type of interaction with the page within a specified time interval.

15. The computer program product of claim 14, wherein the type of interaction is selected from a group consisting of: establishing a connection to the page, indicating a preference for the page, sharing the page with another user of the online system, providing a comment for presentation via the page, and any combination thereof.

16. The computer program product of claim 13, wherein the content associated with the user is a page associated with the user and a characteristic of the content associated with the user is selected from a group consisting of: an average frequency with which users of the online system interact with the page within a specified time interval, a change in an amount of user interaction with the page over the specified time interval, a number of times the page is accessed during the specified time interval, and any combination thereof.

17. The computer program product of claim 13, wherein the amount of reach of the content associated with the third party is based at least in part on a number of discrete users of the online system accessing the content associated with the user via the online system.

18. The computer program product of claim 13, wherein the amount of reach of the content associated with the third party is based at least in part on a number of times the content associated with the user has been accessed by users of the online system.

19. The computer program product of claim 13, wherein determine the amount of compensation to receive from the user for presenting the content associated with the third party from the user to present the content to users of the online system via the content associated with the user comprises:
associate amounts of compensation with different ranges of amounts of reach of the content associated with the third party; and
select an amount of compensation associated with a range of amounts of reach including the determined amount of reach associated with the third party.

20. A system comprising:
a processor; and
a computer-readable storage medium having instructions encoded thereon that, when executed by a processor, cause the processor to:
maintain content on an online system associated with a user;
receive a request from the user to present content associated with a third party other than the user via content associated with the user;
determine an amount of reach of the content associated with the third party to users of the online system based on one or more characteristics of the content associated with the user;
determine an amount of compensation to receive from the user for presenting the content associated with the third party to users of the online system via the content associated with the user based at least in part on the determined amount of reach of the content associated with the third party; and
present a notification to the user of the determined amount of compensation.
